(19) United States
(12) Patent Application Publication
(10) Pub. No.: US 2004/0034748 A1
(43) Pub. Date: Feb. 19, 2004

(54) Memory device containing arbiter performing arbitration for bus access right

(75) Inventors: Shigeki Tomishima, Ibaraki (JP); Shiro Hosotani, Hyogo (JP)

Correspondence Address: BURNS, DOANE, SWECKER & MATHIS, L.L.P., P.O. Box 1404, Alexandria, VA, 22313-1404, US

(73) Assignee: Renesas Technology Corp.

(21) Appl. No.: 10/615,234

(22) Filed: Jul. 9, 2003

(30) Foreign Application Priority Data
Aug. 13, 2002 (JP) 2002-235579 (P)

(51) Int. Cl. G06F 12/00

(52) U.S. Cl. 711/150; 711/151; 711/105

(57) ABSTRACT

An arbiter performs activation of memory that corresponds to a bus access request from DSP in parallel with an access to memory that corresponds to a bus access request from CPU, when DSP requests to access the bus before the access to memory that corresponds to the bus access request from CPU has been completed. Therefore, immediately after the access to memory that corresponds to the bus access request from CPU has been completed, the access to memory that corresponds to the bus access request from DSP is allowed, thereby improving processing performance.

### BACKGROUND OF THE INVENTION

1. Field of the Invention

The present invention relates to a memory device that can be shared by a plurality of chips such as a CPU (Central Processing Unit), a DSP (Digital Signal Processor), and more particularly to a memory device containing an arbiter performing arbitration for a bus access right.

2. Description of the Background Art

Recently, systems equipped with CPU chips, memory chips and the like have attained high performance and multi-functions, and in addition to a CPU chip, a DSP, a chip having an operation function, such as a logic circuit (simply referred to as “logic” hereinafter) for performing a floating-point operation are often placed on-board.

FIG. 1 is a block diagram showing an exemplary schematic configuration of a conventional system board having a CPU chip, a memory chip and the like thereon. The system board 101 includes memories 111a-111c, a CPU 112 controlling the entire system, a DSP 113 processing data, and logic 114 performing processing including processing of an operation such as a floating-point operation. It is noted that system board 101 can externally input/output data through a system port.

CPU 112, logic 114 and DSP 113 are connected with memories 111a, 111b and 111c through memory buses, respectively. CPU 112, DSP 113 and logic 114 are connected through a system bus.

CPU 112 mainly controls the entire system while accessing memory 111. Logic 114 performs processing of an operation such as a floating-point operation while accessing memory 111b. DSP 113 performs data processing while accessing memory 111c. CPU 112 receives an operation result from logic 114 and a data processing result from DSP 113 through the system bus to control the system entirely.

FIG. 2 is a block diagram showing an internal configuration of an asynchronous DRAM (Dynamic Random Access Memory) chip as exemplary memories 111a-111c. This asynchronous DRAM chip includes a memory array 121, an address input unit 122 externally inputting an address, an address decoder 123 decoding the address input from address input unit 122, a command input unit 124 externally inputting a command, a control unit 125 interpreting the command input from command input unit 124 for control depending on the command, a data control unit 126 controlling writing data to memory array 121 and reading data from memory array 121, and a data input/output unit 127 inputting/outputting data under the control of control unit 125.

Address decoder 123 selects a memory cell by decoding the address input from address input unit 122 and outputting the decoding result to memory array 121.

Control unit 125 interprets the command input from command input unit 124 to control a refresh operation, a precharge operation, a data reading operation, a data writing operation and the like. If the command is to read data, for example, data control unit 126 reads data from a memory cell selected by address decoder 123 and outputs data externally through data input/output unit 127 under the control of control unit 125.

FIG. 3 is a block diagram showing an internal configuration of a synchronous DRAM chip as another example of memories 111a-111c. This synchronous DRAM chip includes a memory array 131, an address input unit 132 externally inputting an address, an address decoder 133 decoding the address input from address input unit 132, a command input unit 134 externally inputting a command, a control unit 135 interpreting the command input from command input unit 134 for control depending on the command, a clock input unit 136 externally inputting a clock signal, a control unit 137 performing a timing control in accordance with the clock signal input from clock input unit 136, a data control unit 138 controlling writing data to memory array 131 and reading data from memory array 131 under the control of control unit 135, and a data input/output unit 139 inputting/outputting data in synchronization with the clock signal output from control unit 137.

Address input unit 132 externally inputs an address in synchronization with the clock signal output from control unit 137. Address decoder 133 selects a memory cell by decoding the address input by the address input unit 132 and outputting the decoding result to memory array 131.

Command input unit 134 externally inputs a command in synchronization with the clock signal output from control unit 137. Control unit 135 interprets the command input by command input unit 134 to control a refresh operation, a precharge operation, a data reading operation, a data writing operation and the like.

FIG. 4 is a block diagram showing another example of the schematic configuration of a conventional system board having a CPU chip, a memory chip and the like thereon. This system board 102 includes a memory 111, a CPU 112 controlling the entire system, a DSP 113 processing data, logic 114 performing processing including processing of an operation such as a floating-point operation, and an arbiter 115 arbitrating for the right to access a memory bus.

CPU 112, DSP 113 and logic 114 are connected to memory 111 through the memory bus and share memory 111. CPU mainly controls the entire system while accessing memory 111. DSP 113 processes data while accessing memory 111. Logic 114 performs processing of an operation such as a floating-point operation while accessing memory 111.

Arbiter 115 receives a request (Req) signal for acquiring the right to access memory 111 from CPU 112, DSP 113 and logic 114. The respective Req signals are provided with the priorities and arbiter 115 arbitrates for each request according to the respective priorities. Arbiter 115 then outputs an acknowledge (Ack) signal to that chip which acquires the right to access the memory bus.

The chip that receives Ack signal outputs an address (Add) signal and the like and starts accessing memory 111. Arbiter 115 controls memory 111 by outputting Add signal, a command and the like to memory 111.

FIG. 5 is a timing chart illustrating the operation of arbiter 115 mounted on system board 102. In cycle 1, CPU 112 outputs Req signal for acquiring the right to access the memory bus to arbiter 115. In cycle 2, arbiter 115 performs arbitration (Arb) for Req signal. At this point, there is no other chip that outputs Req signal, and therefore in cycle 3, arbiter 115 outputs Ack signal to CPU 112.

When CPU 112 receives Ack signal and recognizes that the right to access memory bus is acknowledged, in cycle 4, CPU 112 outputs Add signal and the like to arbiter 115. At this point, arbiter 115 outputs Add signal, command (Act) and the like to activate memory 115. In cycle 4, DSP 113 outputs Req signal to arbiter 115.

In cycle 5, arbiter 115 performs arbitration for Req signals for acquiring the right to access memory bus. Since CPU 112 is using the memory bus according to the priority, Ack signal is not output to DSP 113. In cycles 6 to 9, arbiter 115 outputs a command to memory 111 in response to the request from CPU 112 and performs reading data (Read) or writing data (Write) from/to memory 111.

In cycle 9, logic 114 outputs Req signal to arbiter 115. In this cycle, arbiter 115 completes reading data or writing data from/to memory 111.

In cycle 10, arbiter 115 performs arbitration for Req signals for acquiring the right to access memory bus. Since DSP 113 is using the memory bus according to the priority, Ack signal is not output to logic 114. In this cycle, arbiter 115 outputs Ack signal to DSP 113.

In cycle 11, DSP 113 outputs Add signal and the like to arbiter 115. At this point, arbiter 115 outputs Add signal, a command (Act) and the like to memory 111 to activate memory 111.

In cycles 13 to 16, arbiter 115 outputs a command to memory 111 in response to the request from DSP 113 and performs reading data (Read) or writing data (Write) from/to memory 111.

When arbiter 115 completes reading data or writing data from/to memory 111, arbiter 115 outputs Ack signal to logic 114 in cycle 17. The similar processing is thereafter performed.

In system board 101 shown in FIG. 1, no conflict over the memory access right occurs since the respective separate memories are connected to CPU 112, DSP 113 and logic 114.

The number of memory chips mounted on system board 101, however, is increased. As applications have increasingly attained high performance and multi-functions, the number of chips mounted on system board 101 has been increased accordingly, resulting in that the mounted area is inevitably increased. This contradicts the tendency for recent information terminal equipment to attain portability.

In addition, since the capacity of a standard memory chip is defined beforehand, it is difficult to obtain a memory having a capacity required for CPU 112, DSP 113 and logic 114 each. Therefore a memory having a capacity larger than the required capacity is often used. Unfortunately, this increases the cost for the entire system.

On the other hand, in system board 102 shown in FIG. 4, the problem of system board 101 shown in FIG. 1 can be solved, since CPU 112, DSP 113 and logic 114 share memory 111. In the case where Req signals from CPU 112 and DSP 113 are in conflict as described above, however, Ack signal is not output to DSP 113 until the access to memory 111 by CPU 112 has been completed. Therefore the processing performance of the entire system is deteriorated.

### SUMMARY OF THE INVENTION

An object of the present invention is to provide a memory device in which reduced processing performance of the entire system can be prevented.

Another object of the present invention is to provide a memory device in which an increased area for mounting chips on a system board can be prevented.

In accordance with an aspect of the present invention, a memory device includes a memory unit and an arbiter controlling the memory unit while arbitrating for bus access requests from a plurality of units. When a second bus access request takes place before an access to the memory unit that corresponds to a first bus access request has been completed, the arbiter performs activation of the memory unit that corresponds to the second bus access request in parallel with the access to the memory unit that corresponds to the first bus access request.

Since the arbiter performs activation of the memory unit that corresponds to the second bus access request in parallel with the access to the memory unit that corresponds to the first bus access request, the access to the memory unit that corresponds to the second bus access request is allowed immediately after the access to the memory unit that corresponds to the first bus access request has been completed. As a result, processing performance can be improved. Furthermore, since a plurality of units can share the memory device, an increased area for mounting chips on the system board can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an exemplary schematic configuration of a conventional system board having a CPU chip, a memory chip and the like thereon.

FIG. 2 is a block diagram showing an internal configuration of an asynchronous DRAM chip as an exemplary memories 111a-111c.

FIG. 3 is a block diagram showing an internal configuration of a synchronous DRAM chip as another example of memories 111a-111c.

FIG. 4 is a block diagram showing another example of a schematic configuration of a conventional system board having a CPU chip, a memory chip and the like thereon.

FIG. 5 is a timing chart illustrating an operation of arbiter 115 mounted on system board 102.

FIG. 6 is a block diagram showing a schematic configuration of a system board in an embodiment of the present invention.

FIG. 7 is a timing chart illustrating an operation of an arbiter 15 contained in memory 11 in the embodiment of the present invention.

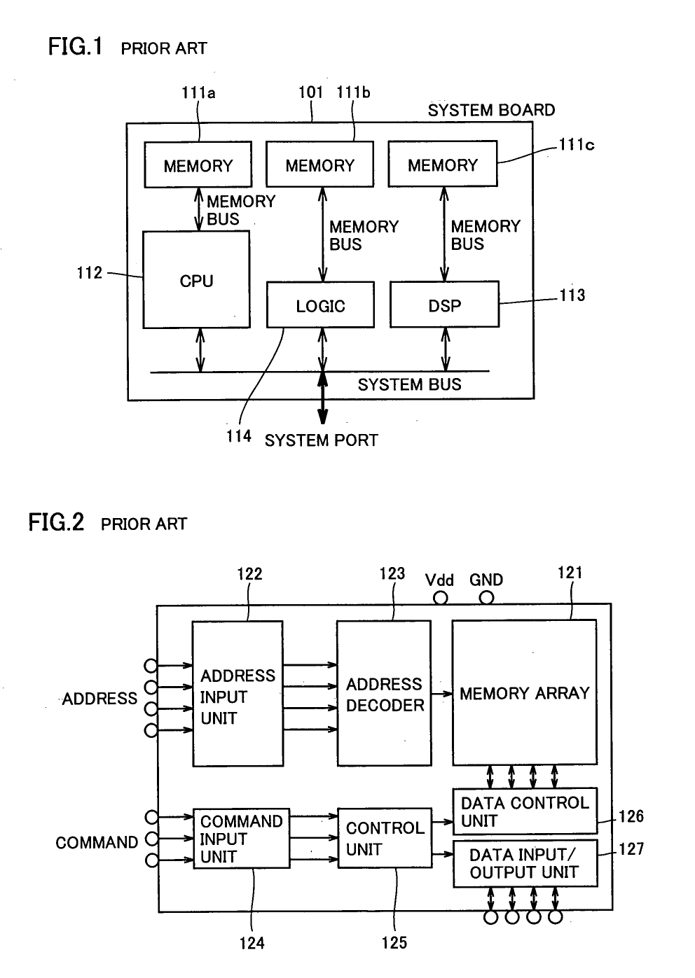

### DESCRIPTION OF THE PREFERRED EMBODIMENT

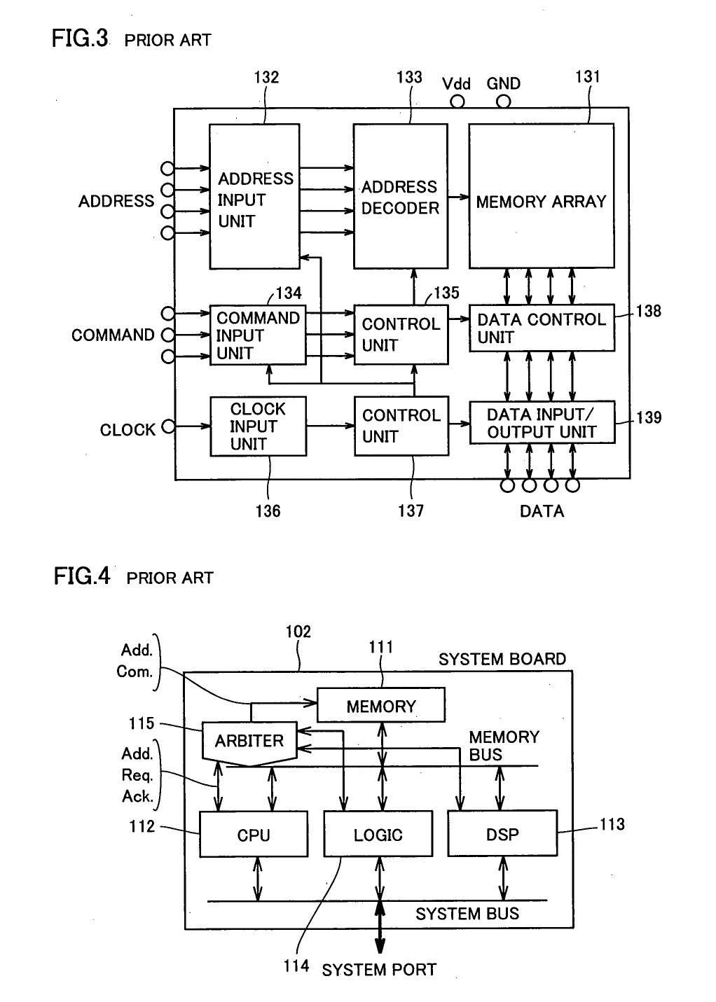

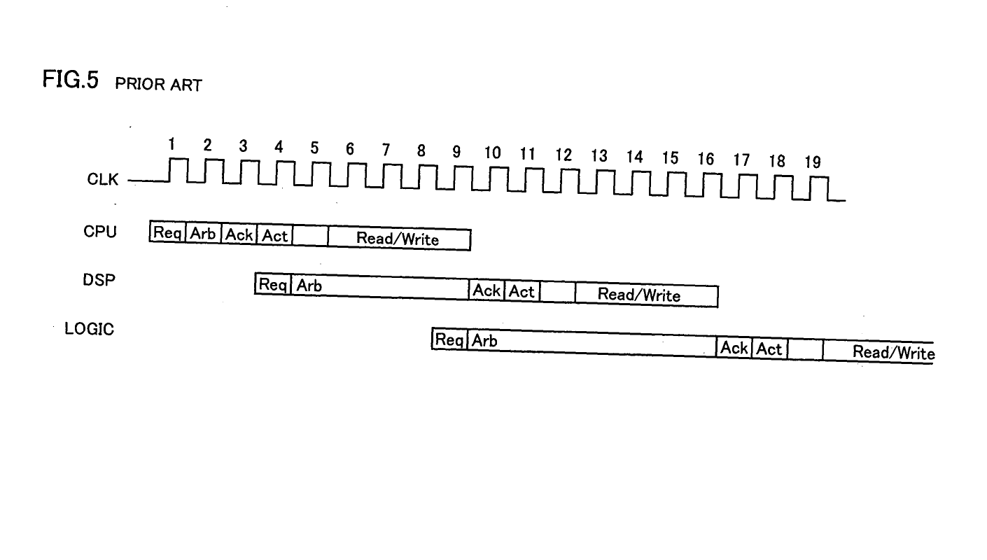

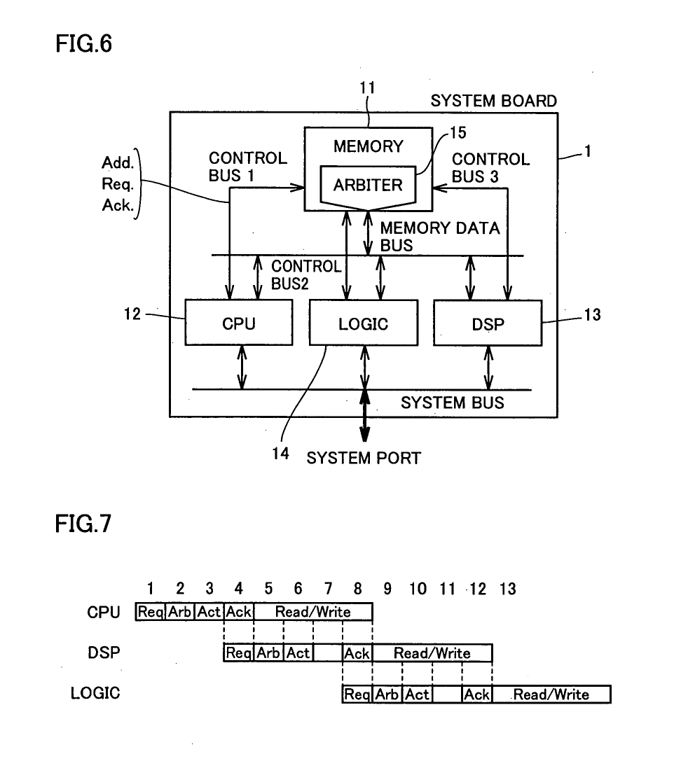

FIG. 6 is a block diagram showing a schematic configuration of a system board in an embodiment of the present invention. System board 1 includes a memory 11, a CPU 12 controlling the entire system, a DSP 13 processing data, and logic 14 performing processing including processing of an operation such as a floating-point operation. Memory 11 includes an arbiter 15 arbitrating for the right to access a memory bus. Memory 11 has an internal configuration similar to that of the asynchronous DRAM chip shown in FIG. 2 or the synchronous DRAM chip shown in FIG. 3 except that it includes arbiter 15, and therefore description thereof will not be repeated.

Each unit such as CPU 12, DSP 13, or logic 14 is connected to memory 11 through the memory bus to share memory 11. CPU 12 mainly controls the entire system while accessing memory 11. Logic 14 performs processing of an operation such as a floating-point operation while accessing memory 11. DSP 13 processes data while accessing memory 11.

CPU 12, DSP 13 and logic 14 are connected to memory 11 through respective separate control buses 1-3. Each of control buses 1-3 includes an address (Add) signal, a request (Req) signal for acquiring the right to access the memory data bus, and an acknowledge (Ack) signal for a request.

Arbiter 15 receives Req signals for acquiring the right to access memory 11 from CPU 12, DSP 13 and logic 14. The respective Req signals are provided with priorities and arbiter 15 arbitrates for each request according to the priority. Arbiter 15 then outputs the acknowledge (Ack) signal to that chip which has acquired the right to access the memory bus.

CPU 12, DSP 13 and logic 14 start outputting Add signal before receiving Ack signal. When memory 11 is configured in DRAM with a bank configuration, a row address can be activated before the immediate preceding reading/writing cycle has been completed. Therefore in the present embodiment, memory 11 has arbiter 15 included therein and arbiter 15 has a plurality of address ports, so that arbiter 15 receives an address for the next reading/writing cycle to activate the row address in a different memory bank in advance before the immediate preceding reading/writing cycle has been completed.

FIG. 7 is a timing chart illustrating the operation of arbiter 15 contained in memory 11 in the embodiment of the present invention. In cycle 1, CPU 12 outputs Req signal for acquiring the memory bus access right to arbiter 15. In cycle 2, arbiter 15 performs arbitration (Arb) for Req signal. In cycle 3, since Add signal has already been output from CPU 12, arbiter 15 outputs Add signal, a command (Act) and the like to memory 11 to activate a row address of a memory bank within memory 15 before outputting Ack signal.

In cycle 4, arbiter 15 outputs Ack signal to CPU 12 since there is no other chip that outputs Req signal. In this cycle 4, DSP 13 outputs Req signal to arbiter 15.

In cycle 5, arbiter 15 performs arbitration for Req signal for acquiring the memory bus access right. Since CPU 12 is using the memory bus according to the priority, Ack signal is not output to DSP 13. In cycles 5 to 8, arbiter 15 outputs a command to memory 11 in response to the request from CPU 12 and performs reading data (Read) or writing data (Write) from/to memory 11.

In cycle 6, since Add signal has already been output from DSP 13, arbiter 15 outputs Add signal, a command (Act) and the like to memory 11 to activate a row address of a different memory bank within memory 11.

In cycle 8 in which arbiter 15 completes reading data or writing data from/to memory 11, arbiter 15 outputs Ack signal to DSP 13. In this cycle, logic 14 outputs Req signal to arbiter 15.

In cycles 9 to 12, arbiter 15 outputs a command to memory 11 in response to the request from DSP 13 and performs reading data (Read) or writing data (Write) from/to memory 11.

In cycle 9, arbiter 15 performs arbitration for Req signal for acquiring the memory bus access right. Since DSP 13 is using the memory bus according to the priority, Ack signal is not output to logic 14.

In cycle 10, since Add signal has already been output from logic 14, arbiter 15 outputs Add signal, a command (Act) and the like to memory 11 to activate a row address of a different memory bank within memory 11.

In cycle 12 in which arbiter 15 completes reading data or writing data from/to memory 11, arbiter 15 outputs Ack signal to logic 14. The similar processing is thereafter performed.

It is noted that although in the present embodiment it has been described that separate chips such as memory chip 11, CPU 12, DSP 13, or logic 14 are mounted on system board 1, these functions may be provided in the same chip as in a memory-embedded chip such as an SOC (System On a Chip) or an SIP (System In a Package).

Inmost of the memory chips on system boards, a data bus width is at most ×32 bits (mainly ×16 bits). In the memory-embedded chip, however, the data bus width is sharply increased such as ×128 bits, ×256 bits, and the number of addresses is reduced with the increase in the number of bits. Therefore the configuration of the memory device in the present embodiment is more effective in the memory-embedded chip in which every unit is mounted on a single chip.

It is noted that the configuration of the memory device in the present embodiment mounted on the memory-embedded chip differs from the configuration of system board 1 shown in FIG. 6 only in that the units including memory 11, CPU 12, DSP 13, logic 14 and the like are mounted on a single chip. Therefore detailed description thereof will not be repeated.

As described above, in accordance with the memory device in the present embodiment, memory 11 contains arbiter 15, and arbiter 15 receives an address for the next reading/writing cycle to activate a row address in a different memory bank in advance before the immediate previous reading/writing cycle has been completed. As a result, the number of cycles required to access memory 11 can be reduced and the processing performance of the entire system can be improved.

In addition, since CPU 12, DSP 13 and logic 14 can share memory 14, the increased area for mounting chips on system board 1 can be prevented.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A memory device comprising:
a memory unit; and
an arbiter controlling said memory unit while arbitrating for bus access requests from a plurality of units, wherein
when a second bus access request takes place before an access to said memory unit that corresponds to a first bus access request has been completed, said arbiter performs activation of said memory unit that corresponds to said second bus access request in parallel with the access to said memory unit that corresponds to said first bus access request.

2. The memory unit according to claim 1, wherein
said arbiter outputs an acknowledge signal that corresponds to said second bus access request before the access to said memory unit that corresponds to said first bus access request has been completed.

3. The memory device according to claim 1, wherein
said memory unit has a plurality of memory banks, and
said arbiter has a plurality of address ports corresponding to said plurality of units, and outputs an address corresponding to said second bus access request to said memory unit in parallel with an access to a first memory bank within said memory unit that corresponds to said first bus access request to activate a second memory bank different from said first memory bank.

4. The memory device according to claim 1, wherein
said memory device contains said plurality of units.
